(19) United States
(12) Patent Application Publication
(10) Pub. No.: US 2026/0013005 A1
(43) Pub. Date: Jan. 8, 2026

(54) USER APPLICATION FOR USE IN NOTIFYING THE PUBLIC OF EMERGENCIES

(71) Applicant: Public Safety Council Corp., Wilmington, DE (US)

(72) Inventor: Mark Macy, Toronto (CA)

(73) Assignee: Public Safety Council Corp., Wilmington, DE (US)

(21) Appl. No.: 19/331,843

(22) Filed: Sep. 17, 2025

Related U.S. Application Data
(63) Continuation of application No. 17/975,914, filed on Oct. 28, 2022.
(60) Provisional application No. 63/273,356, filed on Oct. 29, 2021.

(51) Int. Cl. H04W 76/50; H04W 4/90; H04W 72/30

(52) U.S. Cl. CPC H04W 76/50; H04W 4/90; H04W 72/30

(57) ABSTRACT

Systems and methods relating to public notification. A system for public notification of emergency situations or for alerting the public of incidents uses one or more servers in a firewalled environment that is segregated from the general Internet. The system receives a data feed from the REST API of computer aided dispatch systems used by the authorities in a jurisdiction (e.g. police and emergency services). The data is converted into standardized nomenclature and is transmitted to apps installed on user computing devices.

### CROSS REFERENCE TO RELATED APPLICATIONS

This application is a continuation of U.S. patent application Ser. No. 17/975,914, filed Oct. 28, 2022, which claims the benefit of U.S. Provisional Application No. 63/273,356, filed Oct. 29, 2021, which are incorporated by reference as if fully set forth.

### TECHNICAL FIELD

The present invention relates to emergency notification systems. More specifically, the present invention relates to systems and methods for the notification of the public during emergencies.

### BACKGROUND

The first few decades of the 21st century has been fraught with challenges in terms of public safety. Between terrorist threats, rampant targeted random attacks at public venues, and the more usual emergencies such as fires, both the public and the emergency services have been constantly assailed.

One issue with emergency situations is that the public, or those who might be affected by an emergency, are generally uninformed about the emergency until either it is too late or after emergency has passed. Absent constantly monitoring emergency radio frequencies or constantly monitoring bulletins from news sources or emergency services, there are no systems for localized notifications about local emergencies.

While there are some notifications systems that are in use, these rely on official notifications from the authorities. Other notification systems rely on social media for data feeds regarding emergencies. Unfortunately, these notification systems require action from authorities or they require positive action from the public before notifications can occur. Such systems require authorities to officially declare emergencies or publish notifications. Alternatively, systems that use social media only work if the public (or the authorities) publish/post about an emergency. Unfortunately, such social media-centric systems may be unreliable as social media posts can be erroneous or they may be hoaxes.

There is therefore a need for systems and methods that can reliably inform the public about emergencies and, preferably, about developing emergency situations. More preferably, such systems and methods would not require an official notification or official action from authorities before emergency bulletins are generated.

### SUMMARY

The present invention provides systems and methods relating to public notification. A system for public notification of emergency situations or for alerting the public of incidents uses one or more servers in a firewalled environment that is segregated from the general Internet. The system receives a data feed from the REST API of computer aided dispatch systems used by the authorities in a jurisdiction (e.g. police and emergency services). The data is converted into standardized nomenclature and is transmitted to apps installed on user computing devices.

In one aspect, the present invention provides a system for providing online emergency notifications to subscribers, the system comprising
a feed reception module for receiving a data feed from a data source; and
a server for receiving said data feed from said feed reception module, said server being for converting data in said data feed into a notification feed for distribution to said subscribers,
wherein
said data source being directly connected with established emergency authorities;
said server is segregated from a general Internet;
after said data is converted into said notification feed, said notification feed is distributed to said subscribers.

### BRIEF DESCRIPTION OF THE DRAWINGS

The embodiments of the present invention will now be described by reference to the following figures, in which identical reference numerals in different figures indicate identical elements and in which:

FIG. 1 is a schematic diagram of a system according to one aspect of the present invention; and

FIG. 2 is another schematic diagram of another aspect of the system illustrated in FIG. 1.

### DETAILED DESCRIPTION

In a first aspect, the present invention includes systems that provide notifications to users by way of a computing device. The computing device may be a mobile communications device (e.g. a smartphone), a mobile computing device (e.g. an Internet connected tablet or laptop), or a desktop computing device. The system includes one or more servers that receive data input from a number of sources. These sources may include unfiltered feeds from one or more computer aided dispatch systems used by one or more jurisdiction's law enforcement/emergency authorities. Such authorities may include the police/law enforcement, fire departments, fire-rescue authorities, first responder authorities, rescue authorities/agencies, authorities that manage/operate 9-1-1/1-1-2/3-1-1/9-9-9 emergency communications hubs, and other similar authorities/agencies.

The server or servers according to one aspect of the present invention may poll the REST API for the computer aided dispatch (CAD) systems/software used by the authorities.

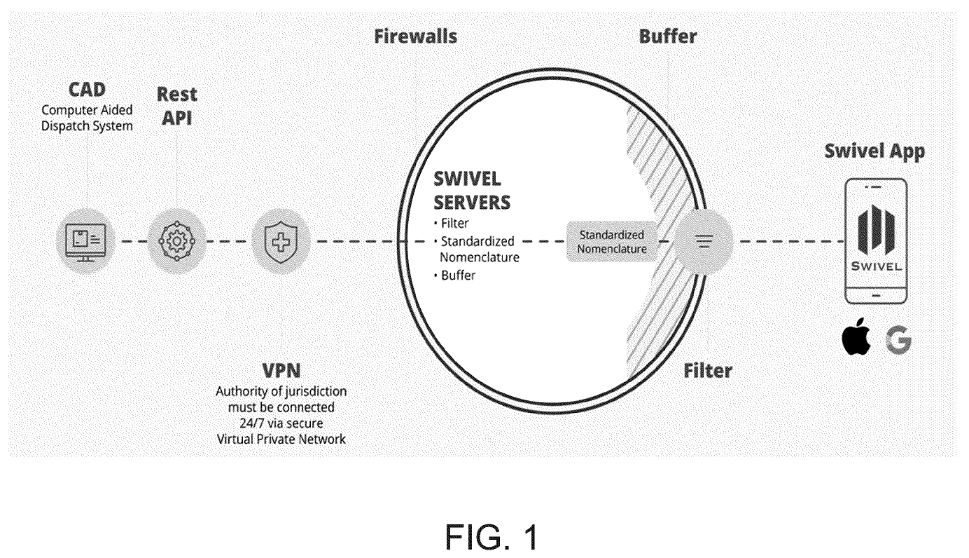

To better explain the system, FIG. 1 provides a schematic illustration of the system. As can be seen, the system of the present invention uses a direct feed from a CAD (computer aided dispatch system) used by authorities and emergency services. The CAD receives data regarding an emergency or a developing emergency situation. This data is sent to a Rest API that is accessible to the system of the present invention. The system uses a VPN and its servers operate within a secure firewalled environment that is isolated from the general Internet. From this firewalled environment, the servers filter and analyze the data from the CAD. The data is then transformed into standardized nomenclature and the resulting data (and the incoming data) is buffered. The alerts (in standardized nomenclature) are them buffered and sent to user devices. The user devices (which are running the alert app noted as Swivel in the diagram) then alerts the users and provides the details of the alerts.

For greater clarity, the firewalled, segregated environment that the servers of the present invention operate in may be implemented using technology as detailed and described in PCT publication WO 2021/042213, the entirety of which is hereby incorporated herein by reference.

It should also be clear that no other system uses a mobile app that operates with data obtained directly from the authorities' CAD systems. The polling of this data is over a VPN as detailed in FIG. 1 and as detailed in the PCT application referenced above. Alternatively, the VPN may be over a VPN on the internet.

In terms of operation, once the jurisdiction's authorities (the authorities or the emergency services for the jurisdiction(s) where the system will operate) initialize the system with the authorities' CAD system's REST API, the system is fully automated within their jurisdiction. This means that any emergency situations noted in the CAD data will be analyzed/transformed into standardized nomenclature and alert notifications using this standardized nomenclature will be issued to the users of the app.

For further clarity, the system delivers unfiltered alerts from authorities such as police, sheriff, and fire services in real time, or in near-real time. The system converts the data/alerts into the standardized nomenclature and sends these alerts directly to the mobile smartphone, tablets, and other devices of users through the app. Many of the existing mass notification systems paraphrases, modifies, and puts into context the data received. The system of the present invention merely converts the alerts into standardized nomenclature and issues the alerts. Once the users receive the alerts/public safety notifications, the notified or empowered users can decide how to best adapt to ensure their safety.

While all the data that the system provides to users is polled from the authorities' CAD system's REST API, the system's servers have two unique components that are implemented for each authority—as part of the authorities' initialization process.

The first component is an incident category filter that is applied to the REST API data based on each authority's preferences. One example is that an authority's privacy policy may be to not notify the public of domestic dispute calls and/or mental illness calls. The system's filters would ensure that incidents or emergency situations that fall under these categories are not disseminated through the system to the users. These filters enable the authority to be in control of what data is shared with the public.

The second component is a buffer for each incident category. These buffers enable the authority to be in control of when the data is shared with the public. Each incident category can be sent in real-time or in near real-time (i.e. 30-second delay, 1-minute delay, and up to 20-minutes delay). Thus, if the authority has a policy to only release data after a 1-minute delay for traffic accidents, then the system would filter out traffic incident alerts and these alerts would only be released to the public after a delay of 1-minute after the alert has been received.

Another feature of the system is that it provides each authority with a kill switch that enables the jurisdiction's authority to immediately suspend all auto-notifications within their jurisdiction during an unusual emergency, such as a manhunt. This enables the authority to dispatch its resources as needed without the public's knowledge.

The present invention also has a number of features that may be implemented on an as-needed basis. One of such features is a dashboard that enables authorities to provide updates to active incidents, as-needed. This allows not just a live feed of data from the CAD system used by authorities but also a live feed of official updates from these authorities on emergency situations. Another feature is that the system dashboard (which authorities have access to) permits the authorities to send targeted messages as-needed to users based on a specific geographic address. This allows authorities to provide targeted alerts for users in specific geographic regions. If, for example, a forest fire is about to go out of control, the authorities can send an evacuate alert to users who are near the forest fire vicinity.

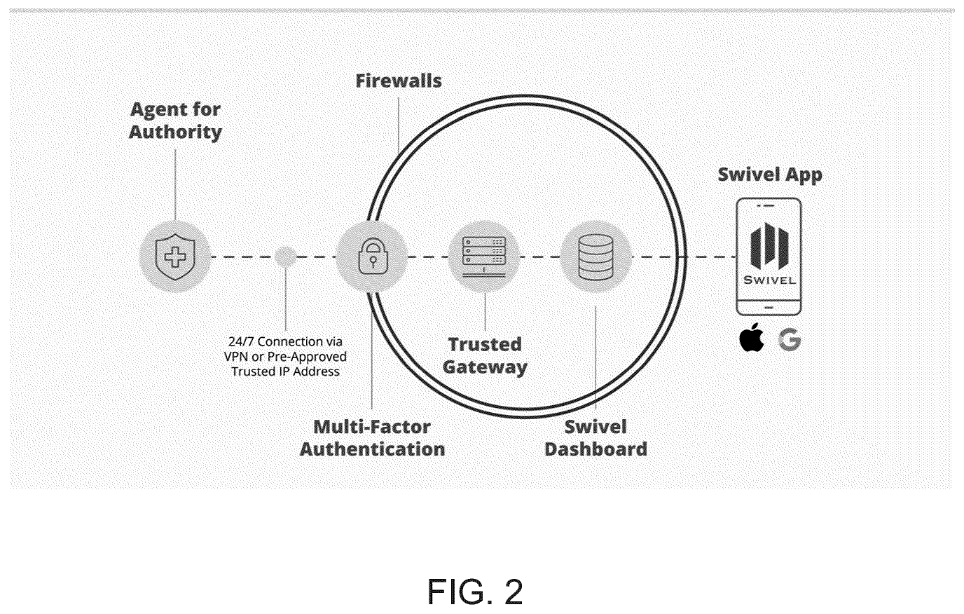

Referring to FIG. 2, a schematic diagram for the as-needed features of the system is illustrated. As can be seen, the authority (or its agent) needs to first pass the multi-factor authentication to access the trusted gateway and the system dashboard. The gateway and the dashboard are within the firewalled and segregated environment as explained above. Once the dashboard is accessed by the agent of the authority, the features that are on an as-needed basis may be activated. The settings activated on the dashboard affect the feed to the user's app and may affect how the system processes/dispatches data/feed to the user app.

Another feature of the present invention is that the system dashboard allows the authority to select an area within their jurisdiction and to send a notification to all users in that selected area. Of course, this is a refinement of the feature noted above.

A further feature of the dashboard is that it allows the authority to select their entire jurisdiction and to send a notification to all users within their jurisdiction. As an example, if the system is being used in LA County and in Orange County, but an alert only applied to LA County, LA County authorities can use the dashboard to send an alert to ONLY LA County located users of the system and not to Orange County users. For clarity, LA and Orange counties are adjacent one another.

For even greater clarity, all of the above features are implemented without divulging any system user personal information to the authorities.

The system is configured such that it does not retain any incident data pertaining to the auto-notification portion of the system. There is no need to retain such data, because this data is already stored in the authorities' CAD system. However, the system does buffer incident data from 0-minutes to 6-hours, as directed by each authority, for ease-of-use in providing updates to active incidents.

On the authority side of the dashboard, each authority using the system dashboard has access to an on-demand audit trail of their agent's use of the dashboard. Thus, any and all interactions between an authority's CAD system and the system of the present invention is logged and this log is available to the authority.

On the user side of the system, each user can configure their app to apply personal filters so that specific incident categories that they do not want to receive notifications for will not be displayed on their app.

The system lists the incident categories within the app and, by doing so, has the side effect of educating the public. By listing the incident categories within the app, the authorities are indirectly educating the public to the many functions the authorities deal with, thereby increasing the public's appreciation of the authority.

Again on the user side of the app, each user can change the notification radius for their smartphone and each user can provide their own addresses of interest. Within the app, each user can designate or tag one or more locations as a centre or address of interest. In the event of an emergency (from the data received by the system) that is within a specified radius of a centre or address of interest, a notification or alert is sent to that user. Thus, if a user designates a specific school as a centre of interest, if a fire breaks out at a building next to the school or at a building near the school, that user is sent a notification or alert. Similarly, a user may designate his or her workplace as a centre or address of interest. If an emergency situation occurs near the workplace, a notification or alert is sent to that user. In a variant of the present invention, the app may designate any location where the mobile is currently located as a centre of interest. Thus, assuming the user has their mobile on their person or nearby, any emergencies occurring near the user's current location will cause an alert or notification to be sent to the app. Of course, the user can configure the settings for the app such that the geographical radius for which alerts are generated as well as the types of incidents that generate alerts are suitably adjusted or adjustable.

As such, each user can add addresses of interest such as: home, workplace, daycare, schools, colleges, universities, cottage, recreational facilities, places of worship and other places of interest or concern.

Another feature of the dashboard is that the authority is provided feedback on how many system users receive one or more specific notifications. Thus, if there is a traffic accident at a specific location, the authorities may be provided feedback as to how many users were provided with an alert about that specific traffic accident.

The embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g., “C” or “Go”) or an object-oriented language (e.g., “C++”, “java”, “PHP”, “PYTHON” or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

We claim:

1. A system for providing online emergency notifications to subscribers, the system comprising
a feed reception module for receiving a data feed from a data source; and
a server for receiving said data feed from said feed reception module, said server being for converting data in said data feed into a notification feed for distribution to said subscribers,
wherein
said data source is directly connected with established emergency authorities;
said server is segregated from a general Internet;
after said data is converted into said notification feed, said notification feed is distributed to said subscribers; and
said server uses a VPN.

2. The system according to claim 1, wherein said data source is a computer aided dispatch system operated by at least one of said established emergency authorities.

3. The system according to claim 2, wherein said established emergency authorities is at least one of:
police;
fire services;
emergency medical services;
ambulance services;
law enforcement authorities; and
emergency first responders.

4. The system according to claim 2, wherein said server converts said data into a format using standardized nomenclature.

5. The system according to claim 2, wherein said data feed is accessed by way of a REST API.

6. The system according to claim 1, wherein said server operates behind a firewalled environment.

7. The system according to claim 1, wherein said notification feed is buffered prior to being distributed to said subscribers.

8. The system according to claim 1, wherein said subscribers receive said notification feed by way of at least one data processing device.

9. The system according to claim 8, wherein said notification feed is received by way of an app operating on at least one of: a mobile data processing device, a desktop, a smartphone, and a tablet.

10. The system according to claim 1, wherein said established emergency authorities apply a filter to remove that data relating to specific categories of emergencies such that said specific categories of emergencies are not added to said data feed.

11. The system according to claim 10, wherein said filter is applied for privacy purposes.

12. The system according to claim 1, wherein said established emergency authorities apply a buffer to said data feed such that a timing of release of data relating to specific emergency incidents is controlled by said authorities.

13. The system according to claim 1, wherein said established emergency authorities apply a kill switch to said data feed such that a release of data relating to specific emergency incidents is suspended by said authorities.

14. The system according to claim 1, further comprising a dashboard component accessible to said established emergency authorities for providing notification control to said authorities.

15. The system according to claim 14, wherein said notification control comprises sending targeted notifications to subscribers within a selected geographical area.

16. The system according to claim 14, wherein said notification control comprises sending update notifications to subscribers regarding at least one specific emergency situation.

17. The system according to claim 1, wherein all interactions between said system and said data source is logged to provide an audit trail.

18. The system according to claim 9, wherein each subscriber controls at least one aspect of said notification feed through said app.

19. The system according to claim 18, wherein said at least one aspect includes at least one of:
a notification radius for said notification feed such that notifications regarding situations outside of said notification radius are not sent to said subscriber;
a designation of one or more locations as an address of interest such that said notification radius is centered on at least one of said address of interest; and
a plurality of types of incidents for which notifications will be sent to said subscriber through said notification feed.
